(19) United States
(12) Patent Application Publication
(10) Pub. No.: US 2009/0045002 A1
(43) Pub. Date: Feb. 19, 2009

(54) Wheelchair

(75) Inventors: Anton Cornelis Riemslag, Delft (NL); Miguel Frank Mendes de Leon, AM 's-Gravenhage (NL)

Correspondence Address: DeMont & Breyer, LLC, 100 Commons Way, Ste. 250, Holmdel, NJ, 07733, US

(73) Assignee: A & M CONSULTANCY & INVESTMENTS B.V., NL-2584 AM 's-Gravenhage (NL)

(21) Appl. No.: 12/093,840

(22) PCT Filed: Nov. 15, 2006
(86) PCT No.: PCT/NL2006/050288

§ 371 Date: Sep. 8, 2008

(30) Foreign Application Priority Data
Nov. 15, 2005 (NL) 1030428

(51) Int. Cl. A61G 5/06

(52) U.S. Cl. 180/311; 280/250.1; 280/304.1

(57) ABSTRACT

The invention relates to a wheelchair provided with a support frame that is suspended on at least a rear wheel and a front wheel by means of a rear and front coupling. At least one coupling comprises means that can shift the support frame with respect to at least one wheel axle, such that a torque can be transmitted to the at least one wheel axle. In particular, the means comprise a lever, one end of which is rotatably connected to the relevant wheel axle and the other end of which is rotatably connected to the support frame. The invention also relates to a coupling mechanism, clearly intended for suspending a wheelchair support frame on a wheel of the wheelchair.

The invention relates to a means of transport for personal conveyance, and in particular a wheelchair provided with a support frame that is suspended on at least a rear wheel and a front wheel by means of a rear and front coupling.

Standard wheelchairs generally comprise manually propelled wheelchairs, that are used for example for the conveyance of people with disabilities, and electrically driven wheelchairs that can also be deployed for people with walking difficulties. The first category of wheelchair is generally provided with a relatively large rear wheel having a diameter of approximately 600 mm, and a smaller front wheel having a diameter of approximately 200 mm. The second category is generally provided with 4 relatively small wheels, for example having a diameter of 200 to 250 mm. The latter type of wheelchair is for example known from NL 1023378. A wheelchair is described therein that is provided with a rotating body to prevent the wheelchair from tipping in its direction of travel during use. The known wheelchair can furthermore comprise auxiliary wheels that can be manipulated, enabling the wheelchair to be moved over an elevation in a simple fashion.

However, a number of disadvantages are associated with the known wheelchair. For instance, it is difficult for people with disabilities to pass over bumps using the standard manually propelled wheelchair, and it is virtually impossible for them to get up onto pavements, for example, without assistance. Furthermore, when passing over a per se small obstacle, such as a bump, with the known wheelchair, it is possible for the front wheels to easily block (“brake diving effect”), for the rear wheels to also block and for the wheelchair to tip over backwards. When descending from a pavement, it is possible for the known wheelchair to easily tip over forwards once the front wheels are off the pavement, whereas when the rear wheels descend from the pavement, the wheelchair can undergo a significant jolt. This generally restricts the freedom of movement of people with disabilities and other users to a significant extent or makes them dependent on external assistance.

The object of this invention is to provide a wheelchair of the type referred to in the preamble, that does not have the disadvantages referred to above inter alia.

The wheelchair according to the invention is thereto characterized as described in claim 1. More particularly, the wheelchair according to the invention comprises at least one coupling comprising means that can shift the support frame with respect to at least one wheel axle, such that a torque can be transmitted to at least one wheel axle. Although the front and rear coupling can both be provided with such means, it is advantageous if the rear coupling comprises means that can shift the support frame with respect to the rear axle of the rear wheel, such that a torque can be transmitted to the rear axle of the rear wheel. This means that the force required to get up onto a pavement approximately 10 cm in height for example is so low that it is even achievable for persons with little ability to exert force. As will emerge in more detail below, such force is even almost non-existent with some embodiments of the wheelchair. Furthermore the risk of one or both rear wheels slipping is reduced. Because the support frame is directly coupled to the rear axle of the large rear wheel with the known wheelchair, the force exerted on the rear wheels when ascending onto a pavement is converted into a reaction moment, hence the tendency demonstrated by the known wheelchair to tip over backwards. The wheelchair according to the invention is less affected by this disadvantage. In order to ascend onto the pavement using the rear wheels, the known anti-tip casters generally deployed to prevent the wheelchair from tipping over backwards are also no longer necessary, which is further advantageous for easily ascending onto and descending from pavements and other obstacles.

According to the invention, the wheelchair comprises means that can transmit a torque or moment to at least one wheel axle. It should be noted that the scope of protection conferred by the present invention covers wheelchairs with a physically present wheel axle as well as wheelchairs with a virtual wheel axle. In the latter case, the wheel axle is defined as the virtual center of rotation of the relevant wheel. A wheel having a virtual wheel axle can for example be driven via its rim.

In a first preferred embodiment of the wheelchair according to the invention, the means comprise a roller wheel that is rotatably connected to the support frame and that can move in a rolling fashion in a circumferential ring connected to the relevant wheel. When the relevant wheel travels at any speed into a pavement for example, this structure provides for the possibility for the support frame to make an upward swinging movement, which enables the relevant wheel to remain against the pavement. In doing so, the roller wheel traces an almost circular path with respect to the center of rotation of the wheel. Because the support frame is connected to the roller wheel on its underside, this frame also swings upward. The kinetic energy of the wheelchair and person sitting therein is hereby almost fully converted into potential energy (of the support frame and person sitting therein). Because the support frame in this position is connected to the wheel eccentrically with respect to the axis of rotation of the wheel, such that a torque can be exerted thereon, this wheel starts to move. This movement ensures that the wheelchair will move relatively easily onto the pavement, as will emerge in more detail below.

In a second preferred embodiment of the wheelchair according to the invention, the means comprise a lever, one end of which is rotatably connected to the relevant wheel axle and the other end of which is rotatably connected to the support frame. In normal use—in other words in a position in which the wheels make contact with the ground—the rotatable connection of the lever to the support frame is preferably situated lower than the rotatable connection of the lever to the wheel axle. When the wheelchair is in rest position, the lever will therefore extend in an almost vertical direction due to gravity, between the rear wheel axle and the rotatable connection thereof to the support frame. This rest position is comparable with the rest position of a swing. When reference is made in this application to the transmission mechanism, this is also understood to mean swinging hinge. When the rear wheel travels at any speed into a pavement edge for example and comes to a halt thereagainst, the lever will be drawn from its position of equilibrium by the mass inertia, will rotate around the rear axle and will thus make a swinging movement forwards (in the direction of the pavement edge). Because the support frame is connected to the lever on its underside, this frame will also swing upward. The kinetic energy of the wheelchair and person sitting therein is hereby almost fully converted into potential energy (of the support frame and person sitting therein). Because the support frame in this swing-out position is connected to the rear wheel eccentrically with respect to the rear wheel axle, such that a torque can be exerted thereon, this rear wheel starts to move. The force to be exerted on the rear wheel by the person sitting in the wheelchair to get up onto the pavement is therefore considerably lower than is the case with the known wheelchair. The upswing of the support frame of the wheelchair from its rest position is combined with a gradual slowing of the support frame that is characteristic of an oscillatory motion, which has a pleasant cushioning effect on the person sitting in the wheelchair.

A particularly advantageous embodiment of the wheelchair according to the invention is characterized in that the rotatable connection of the lever to the wheel axle and/or to the support frame comprises means that make the lever and the wheel axle and/or the lever and the support frame freely movable in one direction of rotation and couple them in the other direction. A particularly favorable wheelchair is obtained if the means comprise a freewheel coupling. When reference is made in this application to a freewheel coupling, it is understood to mean a component having drive and driven elements that can move freely in one direction of rotation (the freewheel direction) with respect to each other and that are coupled in the other direction (the reverse direction). In this preferred embodiment, the freewheel coupling acts as a means of exerting a torque on the rear wheel. After the support frame has swung upward out of the rest position toward the maximum swing-out position, the freewheel coupling indeed ensures that rotation of the lever is further wholly or partially prevented around the rear wheel axle and/or around the rotatable connection to the support frame. In this situation, the lever will only be able to return to the almost vertical (rest) position if the rear wheel is also drawn up onto the pavement as it were. During this movement, the lever forms an almost rigid entity with the rear wheel, whereby the entity rotates around the rotatable connection of lever and support frame, with said rotatable connection thus forming a temporarily eccentric point of rotation of the rear wheel with respect to the rear wheel axle. The eccentric point of rotation is closer to the pavement edge, whereby the moment to be surmounted to get up onto the pavement is reduced. Freewheel couplings are known per se, and freewheel couplings appropriate for the invention are for example described in the handbook by Roloff and Matek: “Maschinenelemente; Normung, Berechnung, Gestaltung”, translated into Dutch and published by Academic Service, Schoonhoven, 1996, pages 390-391. A further preferred embodiment comprises a wheelchair whereby the freewheel coupling can be disconnected, so that the wheelchair can be used as a normal wheelchair if required.

The length of the lever can in principle be freely selected. In a preferred embodiment of the wheelchair according to the invention, it comprises means to make the length of the lever adjustable. The reduction in force described above when passing over an obstacle is greater the more the upswing angle of the lever increases to the vertical. When the upswing angle reaches a value at which the hinge point with the support frame is approximately vertically above the edge of the pavement, no or almost no force is required to move the rear wheel up onto the pavement. At a relatively high speed, in combination with a relatively low pavement, it is possible for the hinge point to come to lie past the pavement edge in a horizontal sense. In this case, almost no further external force has to be exerted and there is a flowing movement up onto the pavement. Such an advantage can be easily achieved if the length of the lever is as large as possible, and thus almost equal to the radius of the rear wheel. If the rotation is not prevented, it is also possible for such a situation to occur whereby the wheelchair is gently positioned with the rear wheels against the pavement. With this embodiment as well, when mounting a pavement or another obstacle, there is a temporarily eccentric point of rotation that is now situated vertically below the rear axle. This situation arises for example if the wheelchair is gently positioned with its rear wheels against a pavement. From this halted position, the person sitting in the wheelchair similarly requires less force to get up onto the pavement compared with the known wheelchair. In this embodiment, it is therefore not necessary to travel into the pavement at any particular speed to benefit from the advantage of the swinging hinge.

In yet another preferred embodiment, the wheelchair according to the invention is characterized in that it comprises means to adjust the angle with the vertical through which the lever can be maximally rotated around the rear axle. This can be advantageous for the operating safety of the wheelchair.

In a further preferred embodiment, the wheelchair according to the invention is characterized in that it comprises means to impede or prevent the rotation of the rotatable lever connection to the rear axle and/or to the support frame. If, for example, rotation of the hinge connection of lever to rear axle is impeded or prevented, it will be almost impossible for the lever to swing up, thus making the upswing angle equal to zero. In this situation, the wheelchair according to the invention acts as a regular wheelchair. A temporary locking of the swinging hinge can be achieved in a simple fashion by applying a mechanical connection between lever and support frame. This connection prevents the lever from rotating with respect to the support frame, whereby a rigid entity with the support frame is obtained. The propulsion and other behavior of the wheelchair is almost identical in this preferred embodiment to that of the known wheelchair having approximately the same dimensions.

The wheelchair according to the invention preferably also comprises means to drive the wheelchair manually. These means can for example comprise a driving hoop mounted in the peripheral direction of the rear wheels. Because the coupling of the rear wheel with the support frame in the wheelchair according to the invention is less direct than with the known wheelchair, the rear wheels can easily be moved abruptly forwards over a flat and approximately horizontal road surface by the person sitting in the wheelchair, due to their low mass. With such an abrupt forward movement after which the rear wheels are held, it is possible to gradually start the support frame moving. The possibility of driving the wheelchair in this indirect way is an additional advantage of the inventive wheelchair. If the ground is bumpy, bumps can be passed over relatively easily by manually driving the rear wheels, which can produce a gently swinging movement. Bumps are thus passed on to the support frame in a cushioned fashion, which is advantageous for the comfort of the person sitting therein. The behavior of the wheelchair is hereby almost independent of the weight of the wheelchair and person sitting therein. Due to this extra cushioning effect, the wheelchair can be provided with hard tyres if required, which is favorable for the rolling resistance. An additional advantage is that this spring effect is also present in semi-static conditions. The known springing does not have this advantage, because it is only initiated by vertical mass inertia forces. If required, the wheelchair can also be provided with means to drive the wheelchair by motor.

In a further preferred embodiment of the wheelchair according to the invention, the rotatable connection of the lever to the wheel axle and/or to the support frame comprises a transmission that can transmit forces to the relevant wheel. In a preferred embodiment, this transmission comprises a gear wheel that can engage with a counter wheel connected to the relevant wheel. Optimum results are obtained if the gear wheel and counter wheel are connected to the rear wheel. Another appropriate transmission comprises a pulley. The wheelchair preferably comprises a drive for the gear wheel. This preferably comprises a mechanical drive that can be operated by the person sitting in the wheelchair. In this respect, operation can be effected by means of manual force as well as by using for example a motor with an on/off button. From the rest position, in which the lever is situated in an almost vertical position, a turning of the gear wheel is brought about in addition to a rotation of the rear wheel around the rear axle and an upswing movement of the lever. The two possible rotation movements referred to above can hereby occur independently of each other and at the same time. If rolling resistance is low, there will primarily be a rotation of the rear wheel and only a slight upswing movement of the lever. If rolling resistance is low, such as on a flat road, a rotation of the gear wheel in the appropriate direction will bring about a forward movement of the wheelchair. If rolling resistance is high, for example when the rear wheel comes up against a pavement, a rotation of the rear wheel is initially impeded, and the gear wheel rises up in the counter wheel, causing the lever to make an upward swinging movement. As rotation continues and the gear wheel is situated vertically above the edge of the pavement, the rear wheel will automatically move up the pavement.

In a preferred embodiment, the wheelchair comprises a motor drive for the gear wheel. A motor assisted rotation of the gear wheel can hereby act as a conventional wheelchair drive on a flat road. When the wheelchair comes up against a pavement or another obstacle, the increased running resistance automatically brings about an increase in the upswing angle of the lever, and therefore, according to the mechanism outlined in detail above, the easy mounting of the pavement without jolting.

Another preferred embodiment of the wheelchair according to the invention has a motor drive comprising a freewheel coupling. The freewheel coupling hereby blocks any rotation counter to the direction in which the motor is rotating. This makes it possible to interrupt the drive even before the rear wheel reaches the top of the pavement, whereby the relevant upswing angle is retained and the lower hinge point forms an eccentric point of rotation as already discussed above. The lower hinge point therefore corresponds to the rotatable connection of the lever to the support frame. From this position of the lever in rest, the person sitting in the wheelchair can opt to continue mounting the pavement manually. With the motor switched on and in the presence of the freewheel coupling referred to above, the person sitting in the wheelchair can opt to manually support the movement if required. In the driven state, the freewheel coupling allows the wheelchair to travel faster than the driven speed. It is thus for example possible to perform a manual sprint in the driven state, or to make contact at greater speed with an obstacle to be surmounted.

The preferred embodiment whereby the gear wheel is driven by a mechanical drive that can be operated by the person sitting in the wheelchair, can for example comprise a second driving hoop mounted on each rear wheel, said hoop having a smaller diameter than the usual hoop. To this end, the second hoop is not directly connected to the rear wheel, but to a central axle that runs for example concentrically to the rear wheel axle toward the inside of the rear wheel, and drives the gear wheel.

The wheelchair according to the invention is also advantageous for placing the front wheels on an elevation or pavement. When the front wheels are placed against the pavement, the forward movement of the support frame of the wheelchair is impeded, while the rear wheels can continue to be moved forward. This displaces the center of gravity of the wheelchair and person sitting therein backwards with respect to the central axle of the rear wheel, and reduces the weight on the front wheels so that they can get up onto the pavement with less force. This means that it is also possible for the center of gravity of the wheelchair and person sitting therein to even lie behind the central axle of the rear wheel, creating the tendency for the wheelchair to tip over backwards, so that the front wheels can be placed on the pavement without any significant force.

In a further preferred embodiment, the wheelchair is characterized in that it comprises means that can shift the support frame with respect to at least one front wheel axle, such that a torque can be transmitted to the relevant wheel axle. These means preferably comprise a lever, one end of which is rotatably connected to the relevant wheel axle and the other end of which is rotatably connected to the support frame. The rotatable connection of the lever to the wheel axle even more preferably comprises a freewheel coupling.

In a further preferred embodiment, the wheelchair is characterized in that it also preferably comprises anti-tip wheels connected to the support frame. The anti-tip wheels permit the wheelchair to tip over backwards up to a specific stable limit value. In rest position, the anti-tip wheels are preferably situated within the radius of the rear wheel, so that they do not form any hindrance, for example when descending from a pavement. When ascending onto a pavement with the rear wheels shifting forwards with respect to the support frame as described, the anti-tip wheels come to lie outside the radius of the rear wheel. This means that the anti-tip wheels are effective when ascending onto a pavement or elevation using the front wheels.

In a further preferred embodiment, the wheelchair, provided with anti-tip wheels, is characterized in that it comprises means to connect the lever temporarily to the support frame when in the situation described above, in which the rear wheels are positioned further forward in comparison with the normal position in rest. In this interlocked situation, it therefore acts as a normal wheelchair, whereby however the center of gravity has shifted backward and can possibly lie behind the wheel axle of the rear wheels. In this way, a stable backward-tipping position of the wheelchair is achieved. The advantage thereof is that the front wheel can be moved up onto the elevation relatively easily, in a manner that is to a lesser extent also usual with regular wheelchairs.

Once the front wheels are situated on the pavement, the wheelchair is further manipulated for ascending onto the pavement using the rear wheels as described above in this application. It is further advantageous if the front wheels of the wheelchair are positioned below the footrest thereof, and therefore positioned further toward the front. This measure increases the wheel base of the wheelchair, in turn benefiting stability. A longer wheel basis also provides a longer distance to build up speed, so that the rear wheels move up onto an elevation more easily.

The wheelchair according to the invention is preferably further provided with a handle for a person pushing the wheelchair, and with control elements for the lever and/or drive and/or freewheel coupling, which are easily accessible from the handle. This simplifies the control of the wheelchair, for example if a pushing person has to load the wheelchair with a person sitting in it into a car.

If the swinging hinge is disconnected, the wheelchair according to the invention can barely be distinguished from the known wheelchair, both in terms of how it looks and how it is used. It should be noted that in addition to the described exemplary embodiments, there are numerous possible embodiments within the scope of the inventive concept. Furthermore the wheelchair can be provided with additional functionality if required, such as for example electrical drive, integrated additional cushioning and the possibility to adjust the height thereof. In this way, the wheelchair can be tailored to meet the specific requirements of the user.

When reference is made in this application to wheelchair, this is understood to mean any personal means of transport. For example the invention is thus also appropriate for sport applications, such as for example bicycles, golf carts, circus equipment with one or more wheels, and other means of transport that regularly have to encounter obstacles.

The invention also relates to a coupling mechanism that is clearly intended for suspending a wheelchair support frame on at least one wheel, the advantages of which have already been described above when describing the wheelchair. The inventive coupling mechanism comprises means that can shift the support frame with respect to the wheel axle of the relevant wheel, such that a torque can be transmitted to the relevant wheel axle. Preferred embodiments of the means comprise a lever, one end of which can be rotatably connected to the relevant wheel axle and the other end of which can be rotatably connected to the support frame, whereby the means also preferably comprise a freewheel coupling.

Further features of the invention will emerge from the non-restrictive preferred embodiments of the wheelchair according to the invention shown in the following figures. The following are shown:

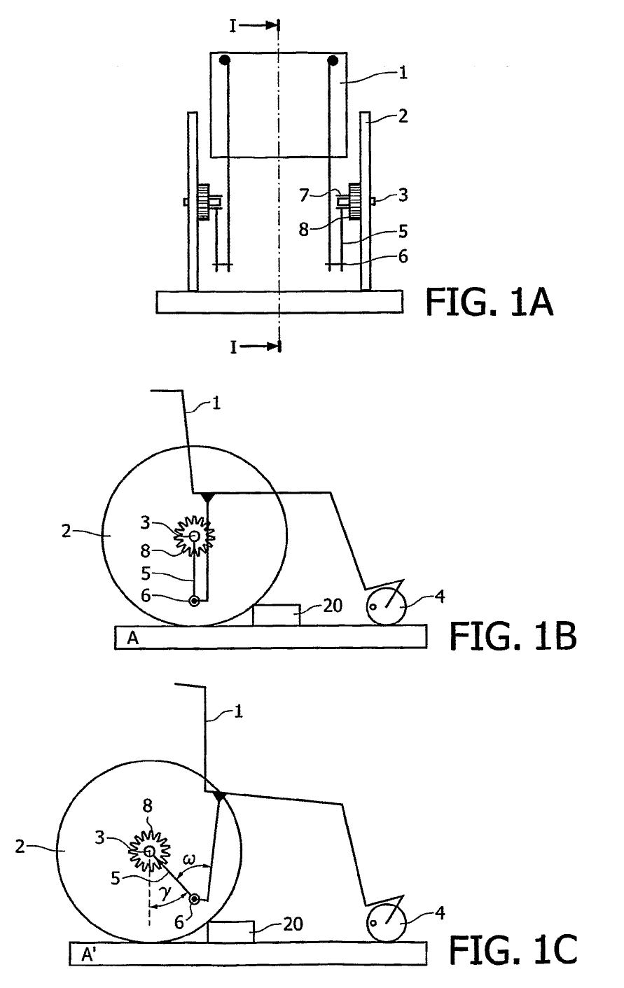

FIG. 1A schematically shows a rear view of an embodiment of the wheelchair according to the invention;

FIG. 1B schematically shows a side cross-section view along line I-I of the embodiment of FIG. 1A in a first position;

FIG. 1C schematically shows a side cross-section view along line I-I of the embodiment of FIG. 1A in a second position;

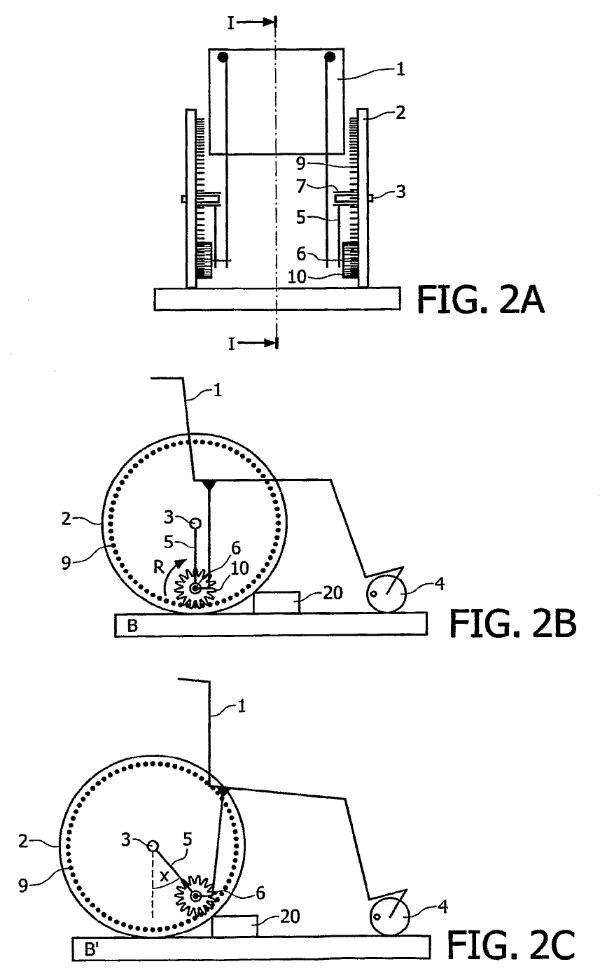

FIG. 2A schematically shows a rear view of another embodiment of the wheelchair according to the invention;

FIG. 2B schematically shows a side cross-section view along line I-I of the embodiment of FIG. 2A in a first position;

FIG. 2C schematically shows a side cross-section view along line I-I of the embodiment of FIG. 2A in a second position;

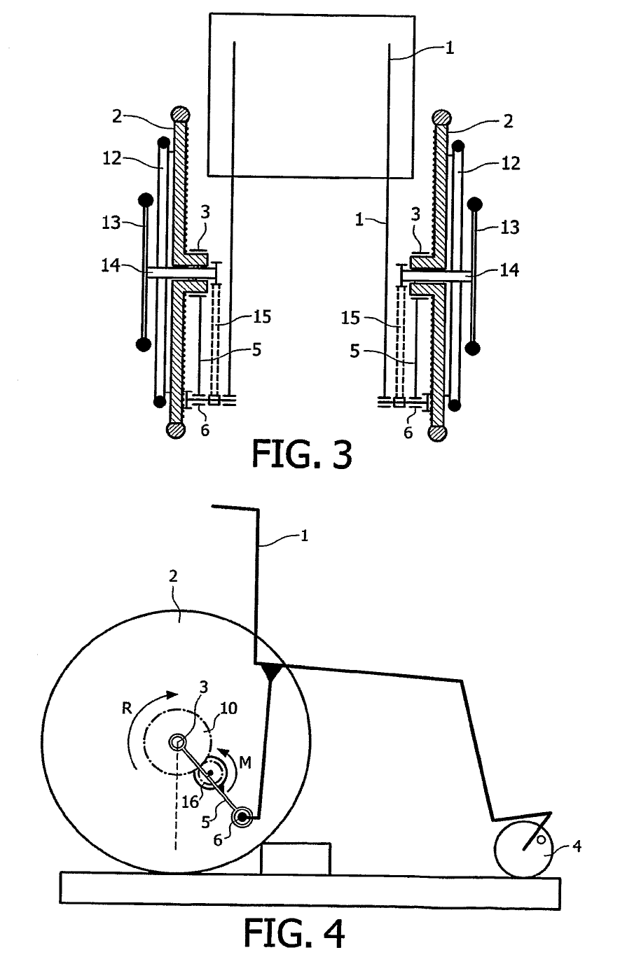

FIG. 3 schematically shows a rear view of yet another embodiment of the wheelchair according to the invention;

FIG. 4 schematically shows a side cross-section view along line I-I of yet another embodiment of the wheelchair in a first position;

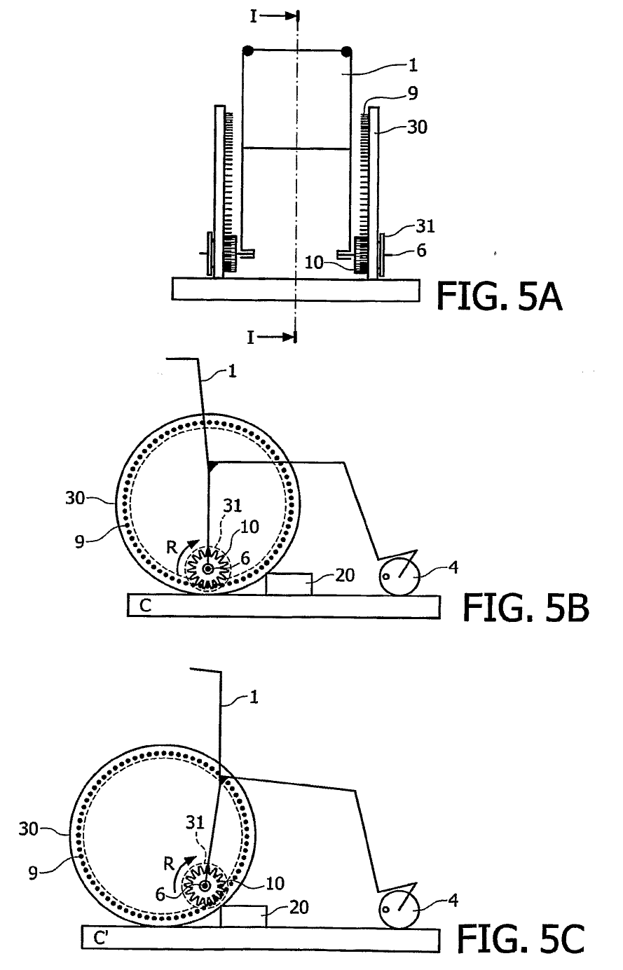

FIG. 5A schematically shows a rear view of another embodiment of the wheelchair according to the invention;

FIG. 5B schematically shows a side cross-section view along line I-I of the embodiment of FIG. 5A in a first position;

FIG. 5C schematically shows a side cross-section view along line I-I of the embodiment of FIG. 5A in a second position;

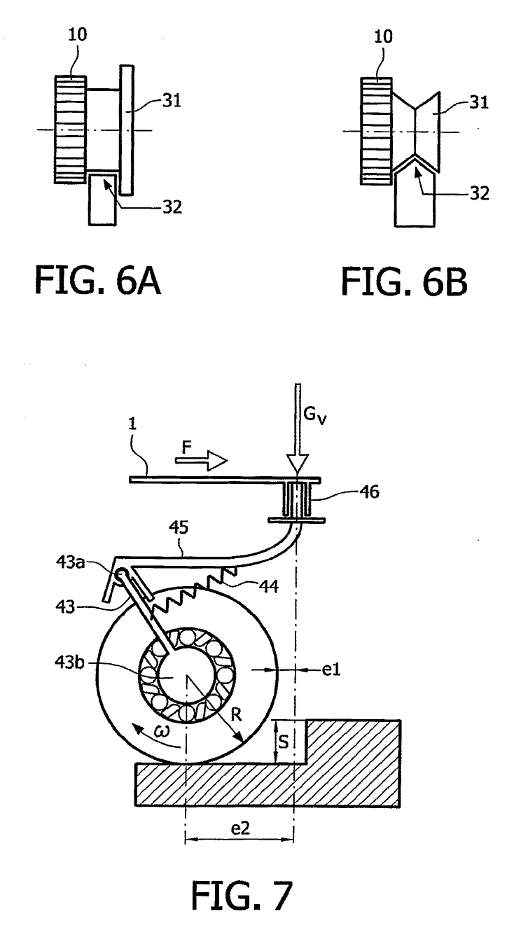

FIG. 6A schematically shows a cross-section of a gear wheel, applicable in the embodiment shown in FIG. 5A;

FIG. 6B finally schematically shows a cross-section of another embodiment of a gear wheel, applicable in the embodiment shown in FIG. 5A;

FIG. 7 schematically shows a cross-section of an embodiment of a front wheel according to the invention;

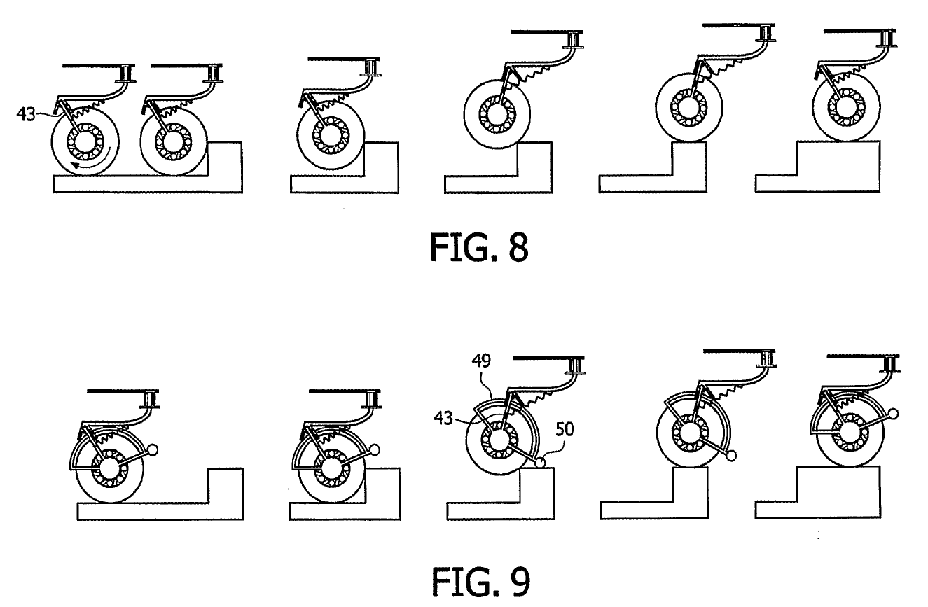

FIG. 8 schematically shows the functioning of the front wheel shown in FIG. 7; and

FIG. 9 schematically shows an alternative embodiment of the front wheel shown in FIG. 7.

With reference to FIGS. 1A, 1B and 1C, a wheelchair driven by the actual person sitting therein is described in a first embodiment, whereby the person manually exerts force in the direction of rotation of the rear wheel (2). The rear axle (3) of each rear wheel (2) is connected to the support frame (1) of the wheelchair via a lever (5). The upper end of the lever (5) can be rotated around the rear axle (3) and forms the upper hinge point (7) of the swinging hinge. The lower end of the lever is rotatably connected to the rear of the support frame (1) and forms the lower hinge point (6) of the swinging hinge. If the rear wheel (2) travels into a pavement (20) at any speed, the support frame (1) makes an upward swinging motion, from position A shown in FIG. 1B to position A′ shown in FIG. 1C. In this latter position, the rear wheel (2) can remain against the pavement (20), and the lever (5) shows an upward swinging angle γ with the vertical direction. The kinetic energy of the wheelchair (and person sitting therein) is hereby converted into potential energy. The upward swinging of the support frame (1) of the wheelchair is combined with a gradual slowing of the wheelchair (and person sitting therein), characteristic of an oscillatory motion. The maximum position of the oscillatory motion is fixed in the embodiment shown by means of a freewheel coupling (8) accommodated in the rear axle (3). The same functionality can also be obtained if required by accommodating a freewheel coupling in the lower hinge point (7). The freewheel coupling (8) ensures that it is only possible for the lever (5) to rotate around the rear axle (3) when there is an upswing (as γ increases). It is only possible for the lever (5) to return to a vertical position (as γ decreases) if the rear wheel (2) moves up onto the pavement (20) as one rigid entity with the lever (5). During this movement, the lever (5) forms one entity with the rear wheel (2), whereby the lower hinge point (6) of lever (5) forms a (temporary) point of rotation for the rear wheel (2), whereby this point of rotation is eccentric with respect to the wheel axle (3). Because the central point of rotation of the rear wheel (3) is displaced toward an eccentric point of rotation (6), as shown in FIG. 1C, the force to be exerted by the person sitting in the wheelchair to get up onto the pavement (20) is less than is the case with the known wheelchair. At a relatively low speed with respect to the height of the pavement, the movement to get up onto the pavement (20) comprises several stages, including creation of speed, upward oscillation of the lever (5) and halting once the maximum upswing angle has been reached, followed by manual operation to climb the last bit of the pavement. The reduction in force with respect to the known wheelchair is hereby substantial and becomes more favorable as the upswing angle γ increases. When the upswing angle γ reaches a value at which the hinge point (6) is situated almost vertically above the edge of the pavement (20), no or almost no force is required to move the rear wheel (2) up onto the pavement (20). At a relatively high speed, in combination with a relatively low pavement (20), it is possible for the point of rotation (6) to come to lie past the edge of the pavement (°) in a horizontal sense. In this case, almost no further external force has to be exerted and there is a flowing motion up onto the pavement.

Even if no upswing angle is created (γ=0), there is a temporarily eccentric point of rotation (6) for mounting the pavement (20), said point of rotation now being situated vertically below the rear axle (3). This situation is shown in FIG. 1B and arises if the wheelchair is gently positioned with its rear wheels (2) against a pavement (20). From this halted position, the person sitting in the wheelchair also requires less force to get up onto the pavement in comparison with the known wheelchair, particularly if the wheelchair is provided with the freewheel function, for example in the form of a freewheel coupling. The exertion of a driving force on the rear wheels (2) by the person sitting in the wheelchair is combined with a reaction force. This reaction force causes a reaction moment, which means that the wheelchair can possibly tip over backwards. By providing the wheelchair with a swinging hinge having a freewheel coupling according to the invention, the tendency to tip over backwards is reduced for two reasons. Firstly the forces to be exerted on the wheels (2) to get up onto the pavement are lower, which means that the reaction moment generated is also low. Furthermore, when the front wheels (4) are placed on a pavement (2), the known wheelchair will have the tendency to tip slightly backwards. This also generally tips the center of gravity of the support frame and person sitting therein further back, which means that tipping backwards requires a lower reaction moment and is therefore promoted. Due to the presence of an upswing angle γ in the wheelchair according to the invention, the wheelchair will tip forward, which will at least partially compensate for the effect referred to above.

On a flat road surface, a wheelchair with swinging hinge (3, 5, 6) and freewheel coupling (8) can be moved forward in the usual manner by a person sitting therein according to the invention, for example by manually driving the rear wheels (2). As shown in FIG. 1B, when in rest position and on a flat and horizontal road surface, some of the weight of the wheelchair and the person sitting therein will push the lower hinge point (6) downward. The upper hinge point (7) of the lever (5) is hereby supported by the rear axle (3) of the rear wheel (2). In this way, the lever (5) will be at rest in an almost vertical position. Because the coupling of the rear wheel (2) with the support frame (2) is less direct than with the known wheelchair, it is possible for the person sitting therein to bring about an abrupt forward movement of the rear wheels (2) due to their low mass. Such a movement also brings about an abrupt shift in the upper hinge point (7) of the lever (5). The lower hinge point (6) is connected to the support frame (1) and will remain behind it due to its greater mass inertia. The lever (5) thus makes an abrupt forward angle (γ<0) with an upswing motion inherently connected therewith. If the person sitting in the wheelchair holds onto the rear wheels (2), the support frame (1) will then gradually be set in motion via the downward oscillatory motion of the lever (5). On bumpy ground, a wheelchair with swinging hinge (3, 5, 6) and freewheel coupling (8) can be moved forward in the usual manner by a person sitting therein according to the invention, for example by manually driving the rear wheels (2). Bumps form a resistance to the propulsion and are combined with a gently swinging motion, so that bumps are passed on to the support frame (1) in a cushioned fashion.

With reference to FIGS. 2A, 2B and 2C, another preferred variant of a wheelchair is shown, whereby the central axle of the lower hinge point (6) of the lever (5) is provided with a gear wheel (10). Gear wheel (10) can rotate around the central axle of the hinge point (6) and if required can be driven. To this end, gear wheel (10) engages with a counter wheel (9) that is connected to the rear wheel (2) in the peripheral direction in a mechanically secure fashion. Various options are available to the person skilled in the art for the technical design of the gear wheel (10) and counter wheel (9), such as for example a gear wheel/gear ring or a connection via a vee belt. From a rest situation shown in FIG. 2B, in which the lever (5) is in an almost vertical position, a turning of the gear wheel (10) in the direction R shown brings about two possible movements, namely a rotation of the rear wheel (2) around the rear axle (3) and an upward swinging movement of the lever (5) in turn producing a growing upswing angle γ. If rolling resistance is low, there will primarily be a rotation of the rear wheel (2) and only a slight upward swinging movement of the lever (5). If rolling resistance is low, such as on a flat road, the rotation of the gear wheel (10) in the direction R shown brings about a forward movement of the wheelchair. If rolling resistance is high, for example when the rear wheel (2) comes up against a pavement (20), a rotation of the rear wheel (2) is initially impeded, and the gear wheel (10) rises up in the counter wheel (9), causing the lever (5) to make an upward swinging movement, as shown in FIG. 2C. As rotation continues and the gear wheel (10) is situated almost vertically above the edge of the pavement (20), the rear wheel (2) will move up onto the pavement (20) autonomously.

If required, the gear wheel (10) can be provided with a motor drive. The motor assisted rotation of the gear wheel (10) then acts as a conventional wheelchair drive on a flat road. When the wheelchair comes up against a pavement (20), the increased running resistance automatically brings about an increase in the upswing angle, and hence the mounting of the pavement (20). The driving of the rear wheel (2) by the gear wheel (10) creates a force on the central axle of the gear wheel (10), and on the support frame (1) connected thereto in a hinged fashion. The lever (5), support frame (1) and gear wheel (10) can all perform an arbitrary rotation around the central axle independently from each other, because they are connected thereto in a hinged fashion. Therefore when the gear wheel (10) is driven, there is almost no moment present. Driving with greater force is thus possible without this causing the wheelchair to tip over backwards. Facilities such as additional support casters are therefore not necessary. This is an improvement with respect to the known wheelchair, where driving the rear wheel indeed creates a moment that can cause the wheelchair to tip over backwards. A design of the known wheelchair with support castors is complex, because they risk losing contact with the ground once the pavement is mounted. In the case of a motor-driven gear wheel (10), the drive torque of the motor also brings about a reaction moment on the casing of the motor. This can be stamped on the lever (5) and brings about a downward force on the rear wheels (2). This is not disadvantageous for mounting the pavement, and need not cause the wheelchair to tip over backwards. By not selecting too large a diameter of the gear wheel (10), and thus creating a large transmission ratio, the drive torque and reaction moment can be freely selected within margins. If the drive is not interrupted when mounting the pavement, there is no need to have a separate freewheel coupling because the freewheel coupling will in that case be integrated as part of switching the drive on and off.

If required, the motor drive can be provided with a freewheel coupling that can block rotation counter to the direction in which the motor is rotating. This makes it possible to interrupt the drive even before the rear wheel (2) gets onto the pavement (20), whereby the relevant upswing angle is retained and the lower hinge point (6) forms an eccentric point of rotation as already discussed above.

With reference to FIG. 3, the driving of the gear wheel (10) can also be performed such that the function of the motor is taken over by the manual force of the person sitting in the wheelchair, via a mechanical transmission. One option for this is to provide each rear wheel (2) with a second driving hoop (13) in addition to the usual driving hoop (12). In this respect, the second driving hoop (13) has a different, for example a smaller, diameter to the usual hoop (12). The second hoop (13) is not directly connected to the rear wheel (2) but to a central axle (14). Central axle (14) runs via a concave section of the main axle (3) toward the inside of the rear wheel (2) and drives gear wheel (10) via a transmission (15), for example a belt or chain. When the second hoop (13) is rotated by the person sitting in the wheelchair, the gear wheel (10) turns with a large transmission, so that the manual forces required are low, and as a result, the tendency to tip over backwards is also reduced. If required, the gear wheel (10) can be provided with a freewheel coupling to prevent any sinking back when the pavement is being mounted, if the driving is interrupted, for example while the rear wheel is manually taken over.

Another preferred variant is shown in FIG. 4. In this variant, the drive for the gear wheel (10) comprises a motor (16) that engages with the gear wheel (10). Rotation of motor (16) in direction M causes a rotation of the gear wheel (10) in the direction R shown. The advantage of this embodiment is that it is more compact than other variants.

With reference to FIGS. 5A, 5B and 5C, yet another embodiment of the wheelchair is shown, whereby the rear wheel is designed as a hoop wheel (30). A possible design of the hoop wheel (30) comprises a rim with a tyre. The inside of the rim is appropriate for a roller wheel (31) to roll around therein. The roller wheel (31) hereby rotates around a central axle (6). The central axle (6) is connected to the support frame (1) of the wheelchair. The central axle (6) of the frame (1) thus also acts as a hinging connection between frame (1) and roller wheel (31). If the rear wheel travels into a pavement (20) at any speed, the above structure provides for the possibility of the frame (1) to make an upward swinging motion, from situation C shown in FIG. 5B to situation C′ shown in FIG. 5C, whereby the rear wheel (2) can remain against the pavement (20). The central axle (6) of the roller wheel (31) hereby traces a circular path with respect to the center of rotation of the rear wheel. This movement is exactly the same as the circular upward swinging movement, as referred to above when discussing the swinging hinge. The properties as referred to when discussing the swinging hinge are thus also applicable for the design with a hoop wheel. A hoop wheel does not generally have a central axle or lever, as is the case with a swinging hinge. The technical design possibilities of the swinging hinge can also be applied to a hoop wheel, in particular the designs relating to elements at the location of the rotatable connection between support frame (1) and lever (S) of FIG. 2C. To fasten the roller wheel (31) sideways, it is possible for the roller wheel to be cylindrical or diabolic in design, as shown in FIGS. 6A and 6B. The inside of the rim must then have a cylindrical or conical inside accordingly. The weight of the wheelchair will usually push the roller wheel (31) onto the inside of the rim. Contact between the roller wheel (31) and the rim can also be maintained via known mechanical structures, such as for example the wheel structure usually applied in roller coaster carts.

The drive described above can be used as a means of support when mounting longer ramps, bridges and access boards of motor vehicles for conveying people with disabilities. When driving the wheelchair up a ramp, an upswing angle is adjusted which compensates for the steepness of the ramp at least partially. This is advantageous with respect to possibly tipping over backwards when going up the ramp.

The swinging hinge with motor drive can also be of use as a facility for descending from a pavement in a controlled manner. When descending from a pavement, the wheelchair tips forward which presents a potential risk for the person sitting therein. This is caused by the generally relatively short wheel base in wheelchairs with respect to the height of the pavement. By holding onto the rear wheels in the driven position prior to descending from the pavement, a small upswing angle can be created, which increases the length of the wheel base and reduces the tendency of the wheelchair to tip forward. The upswing angle also ensures that when coming down onto the road surface below, the jolt is absorbed by a forward movement of the support frame, which has a cushioning effect.

With reference to FIG. 7, a further preferred embodiment of a front wheel of the wheelchair is shown. In more particular, FIG. 7 shows a front wheel that can swivel around a bearing arrangement 46 connected to the support frame 1 of the wheelchair. The front wheel is connected to the support frame 1 via swivel arm 45. The wheel axle 43b is connected to the swivel arm 45 by means of a lever 43. The connection 43a between lever 43 and swivel arm 45 is also rotatable. Free rotation of the lever 43 around connection point 43a is impeded by a draw spring 44 that is arranged between lever 43 and swivel arm 45. An alternative to a draw spring is also possible. On a flat road surface, the lever 43 is drawn against the front stop by the draw spring 44, and this also happens through the action of the vertical load Gᵥ. The wheel axle 43b is further provided with a recoil coupling which means that the front wheel 4 can only rotate in the direction ω shown. A counter direction of rotation is at least partially blocked by the freewheel coupling. As shown in FIG. 7, the running surface of the front wheel is generally situated at a horizontal distance of e2 from the bearing arrangement 46. This eccentricity ensures that the swivel arm 45 will have the tendency to follow the direction in which the support frame 1 is moving. The preferred variant shown makes it easier for a wheelchair user to get up onto the pavement. This is brought about by the fact that the horizontal propulsion force is at least partially converted into a drive torque for the front wheel. Because at least one rear wheel according to an embodiment of the invention is provided with a swinging hinge, the pushing force will increase: this means that the horizontal forward force with which the front wheels push against the pavement is greater than the manual force exerted on the rear wheel. The increase in pushing force arises from a lever action by the swinging hinge structure.

The operation of the preferred variant for the front wheel shown in FIG. 7 is clarified in FIG. 8. When moving forward over a flat road surface, the functionality corresponds to that of the known swivel wheel. The swivel wheel does not encounter any running resistance and remains in the position shown in the left-hand figure. When the front wheel comes up against a high pavement (whether or not at speed), it encounters considerable resistance. The eccentricity e1 now ensures that the front wheels are aligned in the correct position (backwards), as shown in the second figure. In other respects, the front wheel also functions if eccentricity e1<0. An alternative embodiment is based on a dual wheel design, as indeed is applied in baby cars. This also ensures the desired alignment of the front wheel. It is possible to see from the third and fourth figure from the left that a forward force pushes the frame forwards, enabling the lever to tip. The rotation of the lever around the central axle of the wheel is blocked in this direction by the freewheel coupling. With respect to this movement, it is possible to consider the lever and the wheel as a rigid entity. The forwards force exerts a moment on the wheel and a driving torque is produced. This reduces the force required to move the front wheels up onto the pavement. The final tipping is limited by the mechanical stop. The last figure shows the situation whereby the front wheel is situated on the pavement. The angle of the lever against the stop and the spring force of the draw spring must be adjusted such that the wheel will snap forwards, as shown in the figure on the far right.

Finally with reference to FIG. 9, a further improved embodiment of the front wheel 4 is shown, whereby the lever forms part of a support structure 49, that is further provided with a support arm 50. If required, support arm 50 can be provided with a wheel on its free end adjusting to the pavement. As this preferred variant moves up onto the pavement, not only will the lever 43 rotate in a clockwise direction on contact with the edge of the pavement, but the entire support structure 49 will rotate with it. As a result the support arm 50 will come into contact with the pavement and adjust thereto. This promotes the ascending of the pavement and ensures inter alia less slip between front wheel and pavement. The embodiment of the front wheel described in FIGS. 7 to 9 is applied in particular if at least one of the rear wheels is driven by motor.

With the wheelchair according to the invention, a gradual slowing can be achieved when mounting an obstacle such as a pavement for example. Furthermore, by means of a hinge point arranged eccentrically with respect to the wheel axle, less force is required to mount a pavement, whereby the movement can also flow more smoothly than with the known wheelchair. It is also possible to reduce the reaction tip moment due to the reduced driving forces on the rear wheels. This is favorable with respect to the tendency of the wheelchair to tip over backwards when mounting the pavement. The operation of the wheelchair is almost independent of the weight of the person sitting in the wheelchair. It is therefore not necessary for the structure of the swinging hinge to be adapted and/or adjusted for each individual. By temporarily disconnecting the swinging hinge, it is possible in a simple fashion to obtain the functionality of the usual wheelchair. The invention can also be applied for a chair with adjustable height, by fixing the lever at a specific upswing angle γ of the lever, in combination with a mechanism to increase the height of the chair with respect to the front wheels, in such a way that the wheelchair remains approximately horizontal. With the embodiment in which a lever is applied, it is possible to mechanically connect or disconnect the direction-controlled freewheel function by varying the lever angle ω shown in FIG. 1C, which is the angle between lever and support frame.

1. Wheelchair provided with a support frame that is suspended by means of a rear and front coupling on at least a rear wheel and a front wheel, characterized in that at least one coupling comprises means for shifting the support frame with respect to at least one wheel axle, such that a torque is transferred to at least one wheel axle.

2. Wheelchair according to claim 1, characterized in that the rear coupling comprises means for shifting the support frame with respect to the rear axle of the rear wheel, such that a torque is transmitted to the rear axle of the rear wheel.

3. Wheelchair according to claim 1, characterized in that the means comprise a roller wheel that is rotatably connected to the support frame and that can move in a rolling fashion in a circumferential ring connected to the relevant wheel.

4. Wheelchair according to claim 1, characterized in that the means comprise a lever, one end of which is rotatably connected to the relevant wheel axle and the other end of which is rotatably connected to the support frame.

5. Wheelchair according to claim 4, characterized in that, in normal use, the rotatable connection of the lever to the support frame is situated lower than the rotatable connection of the lever to the wheel axle.

6. Wheelchair according to claim 1, characterized in that the rotatable connection to the wheel axle and/or to the support frame comprises means that make the rotatable connection to the wheel axle and/or to the support frame freely movable in one direction of rotation and couple them in the other direction.

7. Wheelchair according to claim 6, characterized in that the means comprise a freewheel coupling.

8. Wheelchair according to claim 4, characterized in that the rotatable connection of the lever to the wheel axle comprises a freewheel coupling.

9. Wheelchair according to claim 6, characterized in that the freewheel coupling can be disconnected.

10. Wheelchair according to claim 1, characterized in that the length of the lever is adjustable up to a length almost corresponding to the radius of the relevant wheel.

11. Wheelchair according to claim 1, characterized in that it comprises means to adjust the angle with the vertical through which the lever can be maximally rotated around the rear axle.

12. Wheelchair according to claim 1, characterized in that it comprises means to impede or prevent the rotation of the rotatable lever connection to the rear axle and/or to the support frame.

13. Wheelchair according to claim 1, characterized in that it comprises means to manually drive the wheelchair.

14. Wheelchair according to claim 1, characterized in that it comprises means to drive the wheelchair by motor.

15. Wheelchair according to claim 1, characterized in that the rotatable connection of the lever to the wheel axle and/or to the support frame comprises a mechanical transmission, in the form of a gear wheel that can engage in a counter wheel connected to the relevant wheel.

16. Wheelchair according to claim 15, characterized in that it comprises a drive for the gear wheel.

17. Wheelchair according to claim 16, characterized in that the drive for the gear wheel is a motor drive.

18. Wheelchair according to claim 16, characterized in that the drive for the gear wheel is a mechanical drive that can be operated by the person sitting in the wheelchair and/or the wheelchair guide.

19. Wheelchair according to claim 17, characterized in that the motor drive comprises a freewheel coupling.

20. Wheelchair according to claim 1, characterized in that it is provided with a handle for a person pushing the wheelchair, and with control elements for the lever and/or the drive and/or the freewheel coupling, which are easily accessible from the handle.

21. Coupling mechanism for suspending a wheelchair support frame on at least one wheel, characterized in that the mechanism comprises means for shifting the support frame with respect to the wheel axle of the relevant wheel, such that a torque is transmitted to the relevant wheel axle.

22. Coupling mechanism according to claim 21, characterized in that the means comprise a lever, one end of which can be rotatably connected to the relevant wheel axle and the other end of which can be rotatably connected to the support frame.

23. Coupling mechanism according to claim 21, characterized in that the means also comprise a freewheel coupling.
